(19) United States
(12) Patent Application Publication
(10) Pub. No.: US 2013/0103918 A1
(43) Pub. Date: Apr. 25, 2013

(54) Adaptive Concentrating Data Transmission Heap Buffer and Method

(71) Applicant: JASON DICTOS, ANN ARBOR, MI (US)

(72) Inventor: JASON DICTOS, ANN ARBOR, MI (US)

(73) Assignee: BARRACUDA NETWORKS, INC, CAMPBELL, CA (US)

(21) Appl. No.: 13/280,268

(22) Filed: Oct. 24, 2011

(51) Int. Cl. G06F 12/02

(52) U.S. Cl. 711/171; 711/173; 711/E12.002

(57) ABSTRACT

An apparatus includes a data container unloading circuit which frees a container either by discarding the contents or transmitting the contents to its destination. A data container loading circuit receives a plurality of submittals of various sizes and selects an appropriately sized free container. If no free container has sufficient capacity the loading circuit blocks all loading until a container of sufficient size becomes available. A container tailor circuit checks for available free space in the buffer and transfers capacity among free containers to resize one to fit an incoming submittal. The mix of container sizes can be adapted over time to reflect the changing sizes of the traffic.

### RELATED APPLICATIONS

None

### BACKGROUND

The field of the invention is network based backup services for many local agents which concentrate their payloads into larger file pieces called shards and smaller meta data chunks which describe the shards.

Cloud-based storage backup services are growing at increasingly rapid rates. Optimization of the communications channel is needed to scale with demand.

Ideally shards should not have to be transmitted more than once but the incidence of new shards is unpredictable. If the buffers are too large, the transmission channel may be poorly utilized resulting in unacceptable backup times.

It is known that data transmission buffers operate sub-optimally when serving streams of mixed large and small size transfers. Particularly, backing up operating systems and databases require differently sized buffers.

What is needed is a data transmission buffer apparatus and method which is adaptive to its workload.

### BRIEF DESCRIPTION OF FIGURES

The appended claims set forth the features of the invention with particularity.

The invention, together with its advantages, may be best understood from the following detailed description taken in conjunction with the accompanying drawings of which:

FIG. 1 is a block diagram of the major control functions and the data flows being controlled;

FIGS. 2-8 are flow chart diagrams of the method embodiments of the invention for operating a server comprising a processor; and

FIG. 9 is a block diagram of a processor executing the method embodiments.

### SUMMARY OF THE INVENTION

An adaptive concentrating buffer keeps a data transmission channel as productive as possible by combining large and small pieces received from a plurality of backup agents.

An apparatus comprises a non-transitory computer readable medium configured as a number of containers. A discarding shipper circuit transforms a loaded container to a free container by either discarding the contents or delivering the contents to a transmission channel. A blocking loading circuit receives submittals of various sizes and selects a free container to load but blocks loading when a container of sufficient capacity is not free for an incoming submittal. A container tailor circuit adjusts free space, if available, among free containers to accommodate an incoming submittal when there is no free container of sufficient size.

Loaded containers are freed by discarding or transmitting their contents. Free containers are expanded or shrunk to accommodate the size of pieces which block further loading.

### DETAILED DISCLOSURE OF EMBODIMENTS OF THE INVENTION

One aspect of the invention is an adaptive buffer apparatus comprising at least one random access memory storage device coupled to control circuits and data reception and data transmission circuits.

Another aspect of the invention is a method for operating the apparatus disclosed.

Advantageously, a transmission channel is kept as fully utilized as possible even though the size of pieces to be transmitted are not uniform or predictable. A random access memory is divided by an dock captain circuit into containers of different sizes which can be adaptively changed to accommodate larger or smaller pieces.

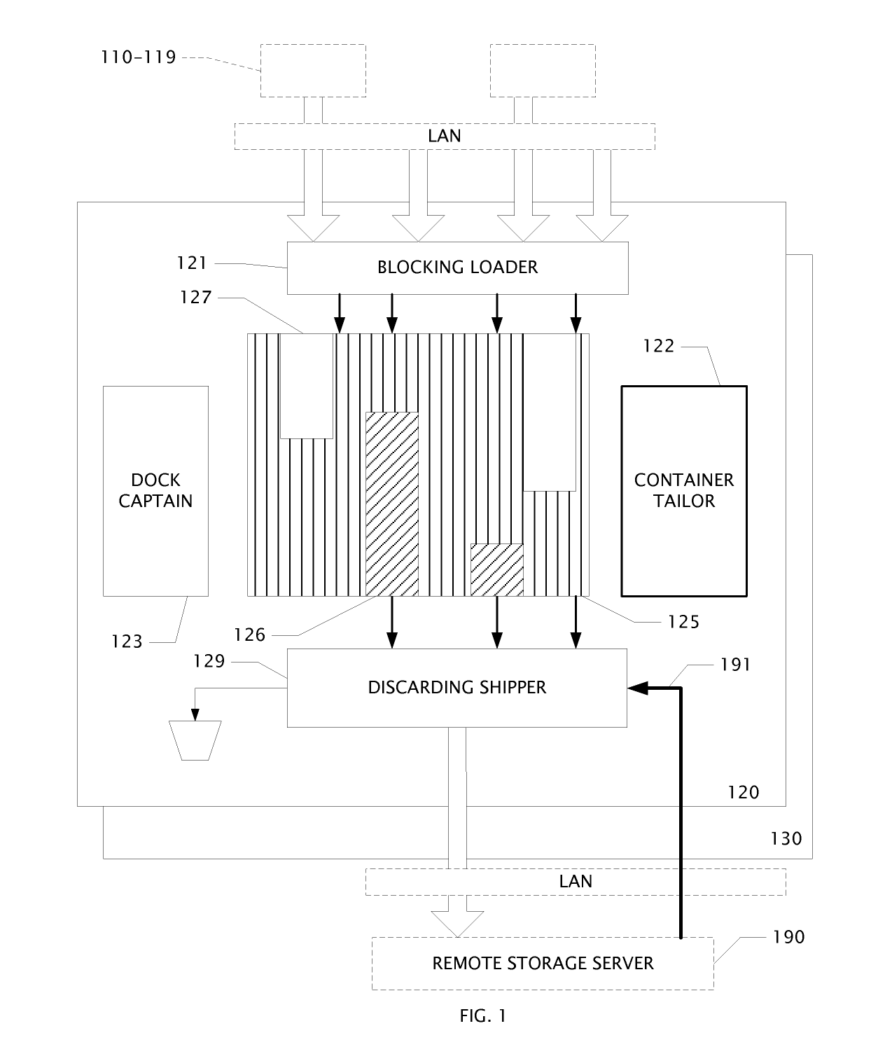

Referring now to FIG. 1 a system is disclosed having a discarding transmission buffer 120 which is communicatively coupled to a plurality of backup clients 110-119 through a high bandwidth channel such as a local area network using Ethernet. A plurality of transmission buffers 120-130 are communicatively coupled to a remote storage server 190 through a medium bandwidth channel such as the Internet using various modem protocols. The backup clients 110-119 each divide files into large shards and compute substantially smaller meta-data on each shard. Unrelated clients may have identical shards which can be determined by examining the meta-data at the remote storage server. Thus, after transmitting a meta-data from a buffer to a remote storage server, it may be determined that the related shard is already present at the remote storage server which removes the necessity of transmitting it again.

The present invention comprises a computer-readable storage 125 which is controlled by a dock captain circuit 123 to be M containers of N size where the total M×N storage is fixed but the size N of containers is adjustable by shrinking one container and growing the size of another container. In an embodiment the number of containers is kept fixed.

The containers are either loaded 126 or free 127. A loaded container becomes free when a transmission circuit 129 either ships the contents or discards the contents. The overall system is scalable because as more clients are added, the likelihood of determination that a shard is already present at the remote storage server increases. Thus the ratio of meta-data to shard transmission is not constant and improves the use of the medium bandwidth channel. When it is determined that a shard is already present 191 at a remote storage server, its container is immediately freed by the discarding/shipper circuit 129 without transmitting the contents. When it is determined that a shard is not already present at a remote storage server, its container is freed after transmitting the contents.

Containers may be resized when there are at least two free containers. A dock captain circuit 123 tracks the size and state of all containers either loaded or free. When a receiving blocking circuit 121 receives content which is larger than any free container it blocks further reception. When the dock captain circuit determines that there is sufficient free space among free containers for received content, a resizing circuit 122 adjusts the size of the free containers until the content may be loaded into a free container. Then the receiving circuit unblocks and resumes receiving content.

As disclosed above an apparatus for buffering data prior to transmission provides a heap queue (not a FIFO pipeline nor a stack). The order of reception into the buffer does not determine the order of emission from the buffer. A computer readable random access storage device is communicatively coupled to a discarding shipper circuit which is coupled to a data communication transmission channel. The discarding shipper circuit is configured to keep the transmission channel as fully utilized as possible without transmitting redundant data. The apparatus further comprises a dock captain circuit which allocates the size and location of the storage device and tracks the available free space within the storage device. The dock captain circuit further defines a fixed number of containers which may be loaded or free. The discarding shipper transforms a loaded container to a free container. In an embodiment, a discard message from the remote storage server may allow the discarding shipper to free the container without transmission.

The apparatus further comprises a blocking loader circuit. The blocking loader circuit receives pieces i.e., shards, and meta-data, from a plurality of agents or clients. The blocking loader selects a free container of sufficient capacity to carry a shard or meta-data piece and turns it from free to loaded. If there are no free containers of sufficient capacity, the blocking loader blocks all loading until a sufficiently large container becomes available.

The apparatus further comprises a container tailor. If there is sufficient free space but no single container of sufficient capacity according to the dock captain, the container tailor shrinks all free containers but one until a container can be resized to unblock the loader. If there is not sufficient free space the loader and container tailor will wait for the discarding shipper to make one or more containers free.

The apparatus comprises a blocking loader circuit, a dock captain circuit, a discarding shipper circuit, and a container tailor circuit all of which are communicatively coupled to a computer readable random access storage device.

The blocking loader circuit is further communicatively coupled to a plurality of agents installed at backup clients which are part of the larger system but external to the present invention. The blocking loader circuit receives pieces of various sizes and loads each one into a free container of sufficient size turning it into a loaded container. When a piece is received by the blocking loader that is larger than any available free container, all loading is stopped until a container of sufficient size becomes free.

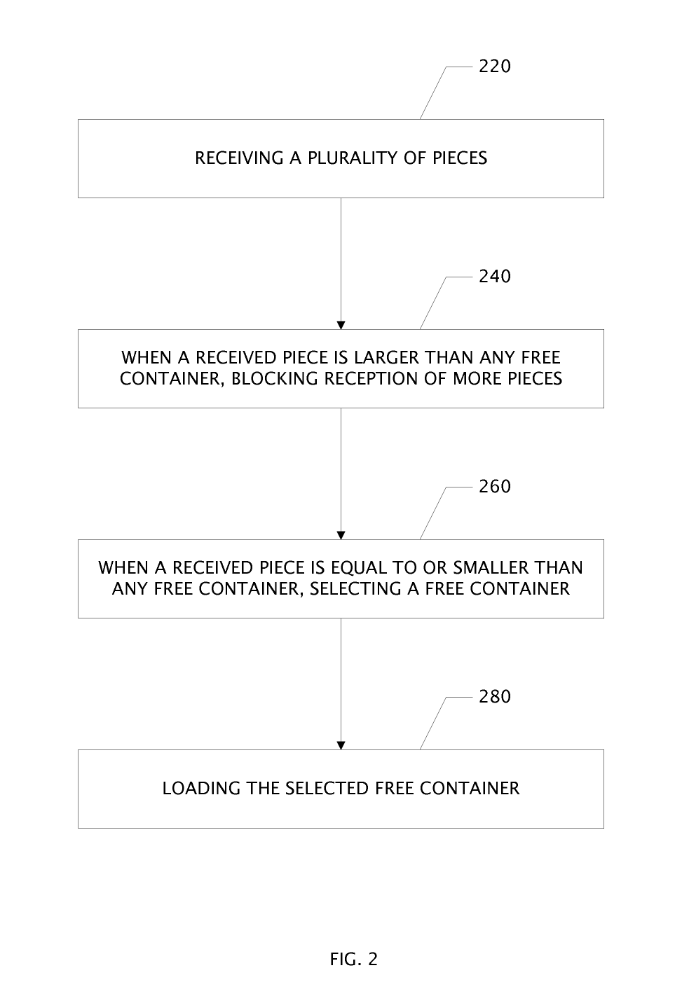

Referring now to FIG. 2, in an embodiment a method for operating a blocking loader circuit is: receiving a plurality of pieces 220, when a received piece is larger than any free container, blocking reception of more pieces 240, when a received piece is equal to or smaller than any free container, selecting a free container that is equal in size or has the smallest wasted capacity 260, and loading the selected free container 280.

A dock captain circuit defines the size and location of the storage device and tracks the amount of free space as well as the size and number of containers. The dock captain circuit is communicatively coupled to all the components disclosed. In an embodiment a container is bounded by a starting address for a random addressable memory and its extent or its ending address.

A discarding shipper circuit is further communicatively coupled to a data communication transmission channel. In an embodiment the discarding shipper circuit is further coupled to a discard message channel which allows a container to be freed without transmission over the data communication channel. In an embodiment, each meta-data is treated as a query with a response defined as either “new” or “found”. If found, the shard associated with the meta-data is duplicative and may be discarded. If new, the related shard is transmitted to the remote server.

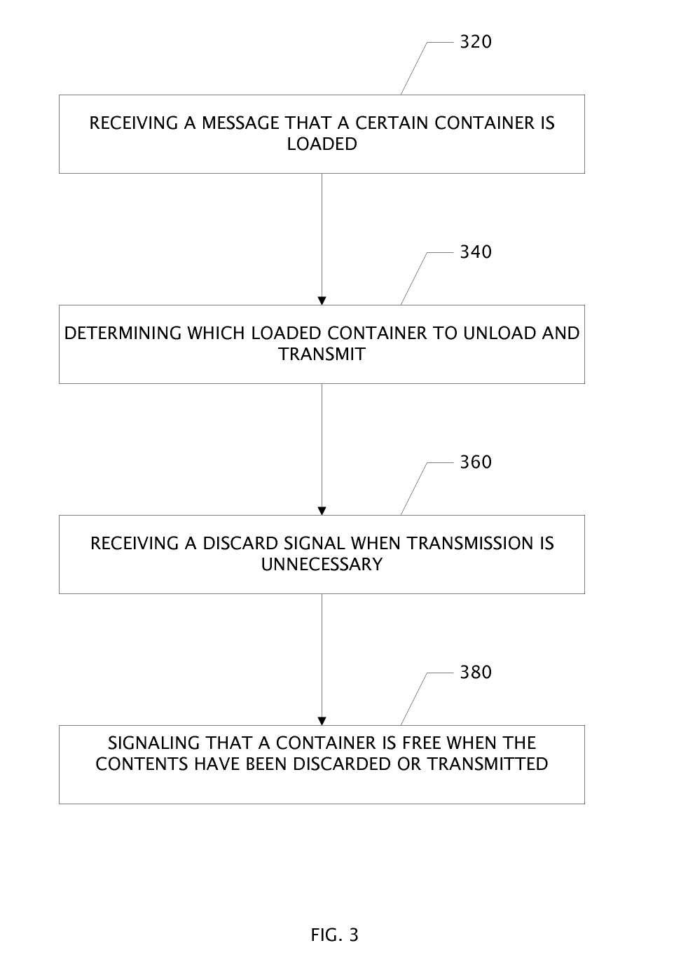

Referring now to FIG. 3, a method for operating a discarding shipper channel comprises: receiving from the blocking loader or the dock captain a message that a certain container is loaded 320, determining which loaded container to unload 340, and signaling that a container is free to the blocking loader when the contents have been discarded or transmitted over the data communication channel 380. In an embodiment the method further comprises receiving a discard signal when transmission is unnecessary 360.

A container tailor circuit is communicatively coupled to the dock captain circuit and to the blocking loader circuit. The container tailor circuit is configured to read the total amount of free space from the dock captain circuit. The container tailor circuit is configured to read the size of a received piece that has caused the blocking loader circuit to block further loading. When the container tailor circuit determines that no free container is large enough but that the total available free space is large enough, it shrinks all but one free container and expands the remaining container to fit the piece which has blocked loading. In an embodiment this is done by changing the start or ending address of free containers.

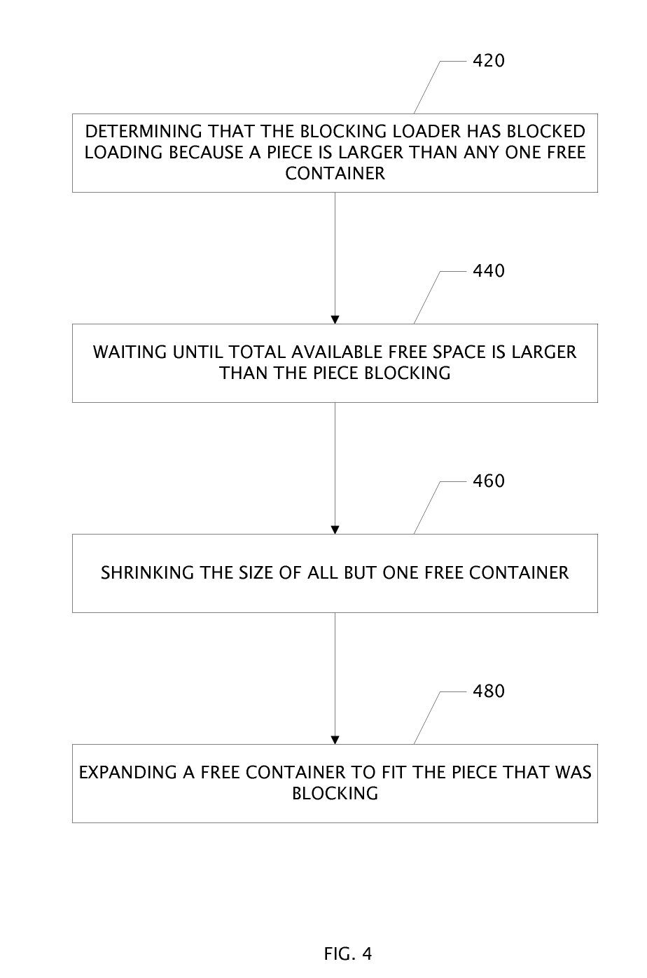

Referring now to FIG. 4, a method for operating a container tailor circuit comprises: determining that the blocking loader has blocked loading because a piece is larger than any one free container 420, waiting until it determines from the dock captain that the total available free space is larger than the piece which is larger than any one free container 440, shrinking the size of all but one free container 460, and expanding a free container in size to accommodate a piece which has caused blocking 480.

As is known in the art the circuits described above may be realized in many electrical embodiments as well as a processor adapted by executable software instruction encoded in machine readable media such as RAM or disks.

One aspect of the invention is a method for operating a buffer comprising a discarding/transmitting process to control a transmission circuit and storage divided into containers. The objective of the method is to keep a transmission circuit as fully utilized as possible. In one process, the discarding transmitting process receives discard messages from a remote store and changes the status of a loaded container to a free container without transmitting the contents. In an embodiment, the discarding transmitting process delays the transmission of the contents of large containers to increase the chance that it will receive a discord message. In an embodiment, the discarding transmitting process prioritizes transmission of the contents of smallest containers to increase the chance that a shard may be discarded. In an embodiment, the discarding transmitting process waits for one of a discard or transmit request from the remote storage server before processing the larger containers. In an embodiment, the process operates as a first in first out buffer for meta-data with a periodic listening window to receive discard messages.

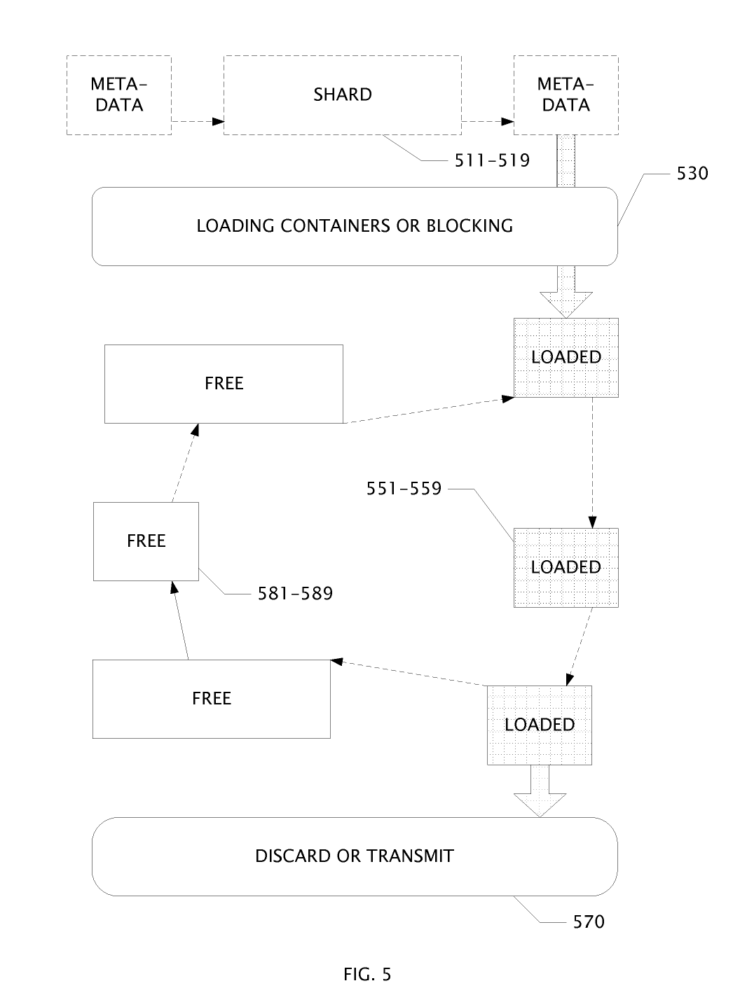

Referring now to FIG. 5, one aspect of the invention is a method for operating a buffer. A receiving/blocking process 530 receives contents of various sizes 511-519 as part of the backup service. In this example they are shards and meta-data describing shards. These are loaded into any one of a plurality of free containers 581-589. The illustration is intended to suggest that containers are alternately free and loaded. It is not restricted to any sequential loading or unloading. The loaded containers 551-559 are unloaded by a discard or transmit process 570. The method comprises identifying at least one free container and its size, receiving contents, when any free container has sufficient capacity for the received contents, storing the contents into the location of the container 581-589 and changing its state from free to loaded 513; when no one free container has sufficient capacity for received contents, loading is paused and reception is blocked until a free container of sufficient capacity is available. Meanwhile the discarding/transmitting process 570 continues to free loaded containers by discarding or transmitting the contents. When a free container of sufficient capacity is available, the receiving/blocking process stores received contents into it, and unblocks reception of new contents.

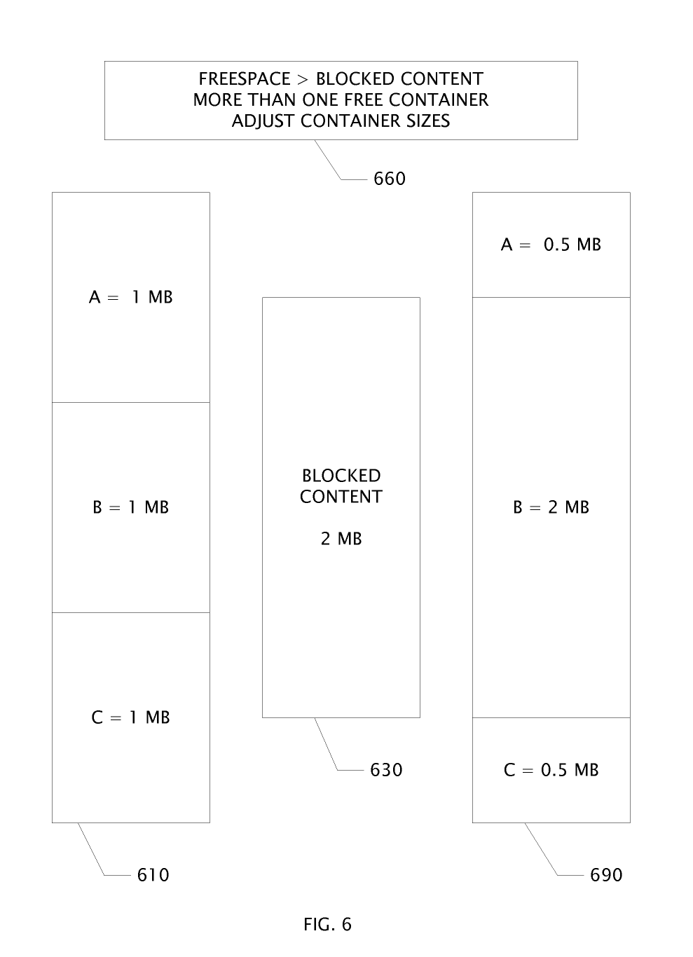

Referring now to FIG. 6, in an embodiment, a third process 660 tracks the total free space among all free containers and their location in the physical store. When the receiving process is blocked because it has received content larger than any available free container 630 and when there is sufficient free space among free containers 610 but not within any one free container, the third process adjusts the size of the free containers 690 so that one has sufficient capacity to unblock the receiving circuit. In an embodiment free containers are resized to a default size when needed. In the illustration, the starting addresses for containers B and C are moved to enlargen container B. Other methods of addressing are equivalent

In an embodiment, a randomly addressable storage device logically partitioned into a plurality of containers by a circuit which tracks the state of each container as free or loaded and tracks the total free space in the storage device, a discarding/transmitting circuit that changes the state of each container from loaded to free either upon receiving a discard message or upon transmitting the contents through a communications link, and a receiving blocking circuit which receives contents from a communications link, and blocks further reception until it can load the received contents into a free container.

In an embodiment the apparatus further includes a container resizing circuit which adjusts the capacities of at least two free containers when no single container has sufficient capacity for a received content and when total free space in the storage device would be sufficient.

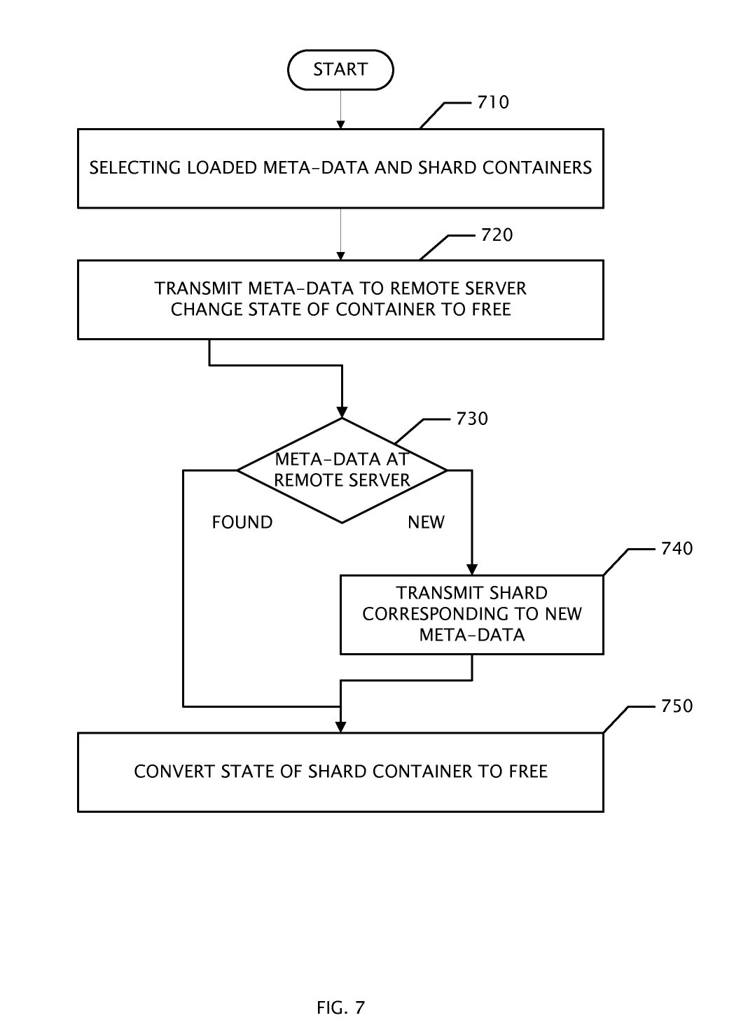

Referring now to FIG. 7, another aspect of the invention is a method 700 for operation of a buffer having a randomly accessible storage device configured as a plurality of containers of adjustable size, a reception circuit, and a transmission circuit,

selecting a loaded meta-data container and a corresponding loaded shard container 710;

transmitting the meta-data to a remote server and changing the state of the container from loaded to free 720;

determining from the remote server that the meta-data is either new or was found already stored at the remote server 730;

When the meta-data is new, transmitting the shard associated with the meta-data to the remote server 740,

when the meta-data is found or after the transmission of the shard, converting the state of the shard container from loaded to free 750. In an embodiment, whenever a container is freed, recomputing the total available free space among all free containers. A separate process receives meta-data and shards from backup clients and loads container when a container of sufficient capacity is available or blocks further reception until one becomes available.

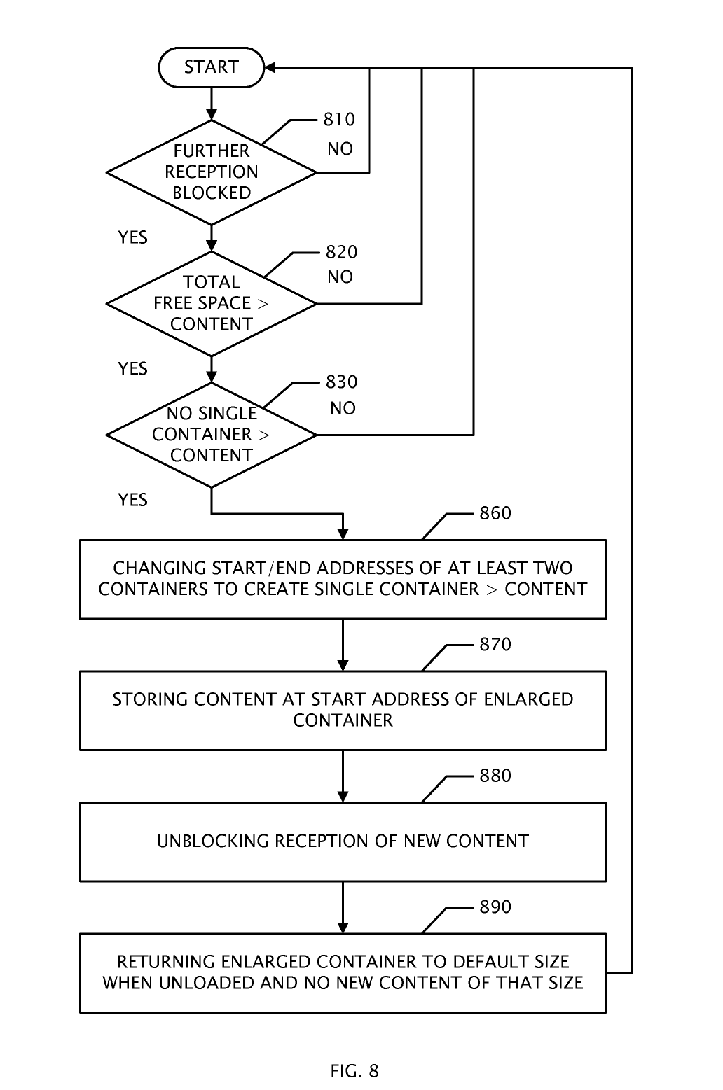

Referring now to FIG. 8, in an embodiment the method 800 further includes: when further reception of content is blocked 810, when total free space is sufficient for received content 820, and when no single container has sufficient capacity 830,

resizing 860 the capacities of at least two free containers to enable loading the received content into one container and unblocking the reception circuit. This may in an embodiment be accomplished by changing a start addresses of containers within the range of random addressable storage and the range or the end addresses of the containers 860. Then when a container is large enough,

storing the contents beginning at the start address of the enlarged container 870. At this point the reception of new content is unblocked 880. In an embodiment, the enlarged container is returned to its default size after being unloaded if there is no further need for a container of that size 890. In an embodiment the method further includes transmitting contents of loaded small containers before loaded larger containers. In an embodiment the method further includes transmitting contents of loaded large containers only upon request of a remote storage server.

In an embodiment the method further includes transmitting the contents of small containers on the priority of first-in-first-out; and/or transmitting the contents of large containers on the priority of largest container last.

### Means, Embodiments, and Structures

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated.

Any of the operations described herein that form part of the invention are useful machine operations. The invention also related to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network-coupled computer system so that the computer readable code is stored and executed in a distributed fashion. Within this application, references to a computer readable medium mean any of well-known non-transitory tangible media.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

### CONCLUSION

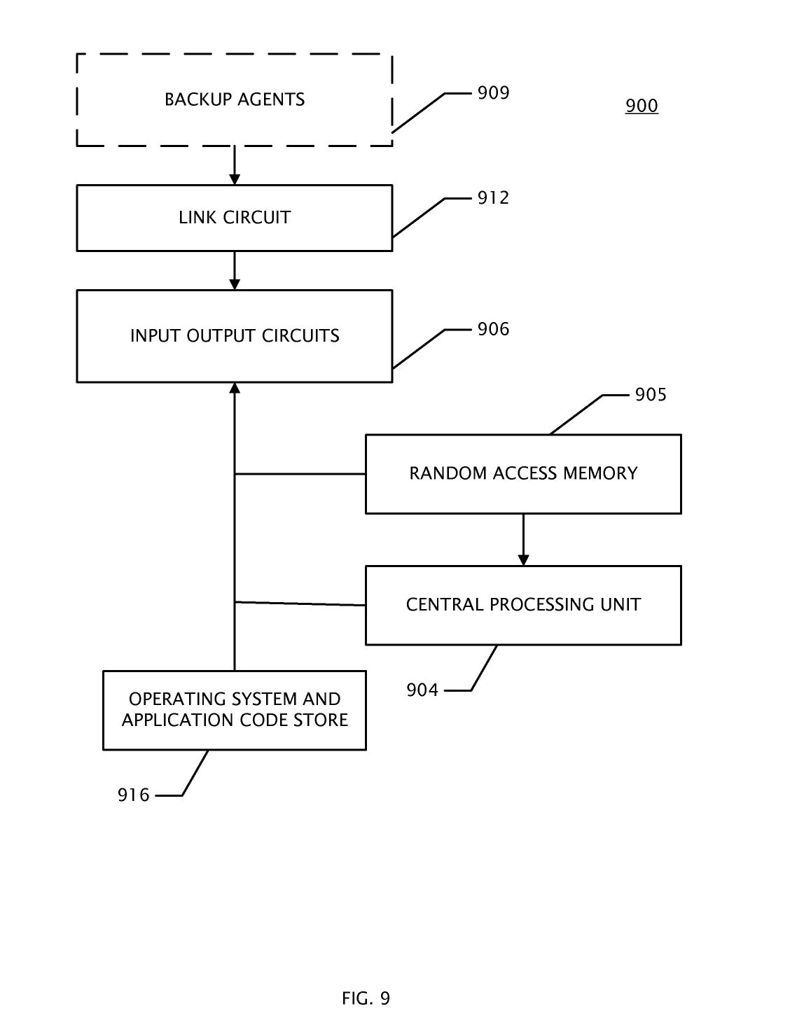

A non-limiting exemplary conventional processor is illustrated in FIG. 9. The processor comprises a hardware platform 900 comprising ram 905, cpu 904, input/output circuits 906, a link circuit 912. In an embodiment, the processor comprises an operating system, and application code 916 which tangibly embodies the encoded computer executable method steps disclosed above in non-transitory media.

The present invention is easily distinguished from conventional buffers by the discarding circuit which reduces the load on the transmission channel. The present invention is easily distinguished from conventional buffers by the container tailor circuit which adjusts container sizes to fit occasional larger pieces. The present invention is easily distinguished from conventional buffers by the dock captain circuit that determines the number and capacity of containers and tracks the total free space.

What is claimed is:

1. A randomly addressable storage device logically partitioned into a plurality of containers by a circuit which tracks the state of each container as free or loaded and tracks the total free space in the storage device, a discarding/transmitting circuit that changes the state of each container from loaded to free either upon receiving a discard message or upon transmitting the contents through a communications link, and a receiving blocking circuit which receives contents from a communications link, and blocks further reception until it can load the received contents into a free container.

2. The apparatus of claim 1 further comprising
a container resizing circuit which adjusts the capacities of at least two free containers when no single container has sufficient capacity for a received content and when total free space in the storage device would be sufficient.

3. A method for operation of a buffer having a randomly accessible storage device configured as a plurality of containers of adjustable size, a reception circuit, and a transmission circuit,
discarding the contents of a container upon a discard message and changing its state from loaded to free,
transmitting the contents of a container and changing its state from loaded to free,
tracking the state of every container either being in a loaded state or a free state the total free space in the storage device,
receiving content on a data communication channel, blocking further reception when there is no available container of sufficient capacity, and
loading contents to a location in the storage device when a container of sufficient capacity is available.

4. The method of claim 3 further comprising
when further reception of content is blocked, when total free space is sufficient for received content, and when no single container has sufficient capacity, resizing the capacities of at least two free containers to enable loading the received content into one container and
unblocking the reception circuit.

5. The method of claim 4 further comprising returning the capacities of containers to a default size after the larger capacity is unneeded.

6. The method of claim 3 further comprising
listening for discard messages.

7. The method of claim 3 further comprising
transmitting contents of loaded small containers before loaded larger containers.

8. The method of claim 3 further comprising
transmitting contents of loaded large containers only upon request of a remote storage server.

9. The method of claim 3 further comprising
transmitting the contents of small containers on the priority of first-in-first-out.

10. The method of claim 3 further comprising
transmitting the contents of large containers on the priority of largest container last.

11. An adaptive data communications buffer apparatus comprising:
a computer readable storage medium of specified size,
a dock captain circuit which defines the specified size, tracks the available free space within the storage medium, define a fixed number of containers utilizing the storage medium, and tracks the current size of the size of each container,
a disposing shipper circuit which transforms loaded containers to free containers coupled to a transmission channel,
a blocking loading circuit which receives incoming submittals and selects a sufficiently sized container for each submittal, and
a container tailor circuit to reallocate free space among container to accommodate incoming submittals when no free container has sufficient space.

12. A method for operating an adaptive data communications buffer apparatus comprising:
within a discarding shipper circuit,
transforming a loaded container to a free container by either disposing of the contents when signaled by the destination that the contents are not wanted, or
delivering the contents to a transmission channel;
within a blocking loading circuit,
selecting a free container of sufficient capacity for an incoming submittal and loading said free container or
blocking loading until a container of sufficient capacity becomes free.

13. The method of claim 12 further comprising
within a container tailor,
resizing a plurality of free containers to enlarge one contain to be sufficient for an incoming submittal when there is sufficient free space in the buffer as a whole and when there is no available container of sufficient size.
